(19) United States
(12) Patent Application Publication
(10) Pub. No.: US 2007/0115947 A1
(43) Pub. Date: May 24, 2007

(54) System and method for routing call traffic

(76) Inventors: Nathan Nelson, Marietta, GA (US); Fred Sherman, Mesquite, TX (US)

Correspondence Address: MCKENNA LONG & ALDRIDGE LLP, 1900 K STREET, NW, WASHINGTON, DC, 20006, US

(21) Appl. No.: 11/024,971

(22) Filed: Dec. 30, 2004

(51) Int. Cl. H04L 12/66

(52) U.S. Cl. 370/356

(57) ABSTRACT

A system and method for routing calls based on the jurisdiction of the originating call and the terminating call includes determining or assigning a jurisdiction to the call before the call is set up. This may be accomplished by determining or assigning a special jurisdictional parameter to each call based on information about the call included as part of the calling protocol.

### BACKGROUND OF THE INVENTION

1. Field of the Invention

The present invention relates to voice communications and telephony in general, and to the routing of telephone call specifically.

2. Discussion of the Related Art

The variety and topology of the communications networks that carry voice traffic, known broadly as voice calls or telephone calls, has increased dramatically in recent years. In the past, telephone calls were routed exclusively over telephone networks owned by a number of companies, each having a monopoly of the lines that carried telephone call traffic within a particular geographic area. However, the simultaneous growth of fiber optic networks and packet switched networks such as the internet has enabled telephone calls between a calling and a called party to be routed over any one of a number of different networks, lines, subject to different costs and lease and ownership arrangements.

Furthermore, while the networks on which telephone calls are routed may differ from one call to the next, it is understood that for each calling party and called party, the access point in to the communications system or network is always the same. In other words, for plain-old-telephone-service (POTS), including those operating on the signaling system 7 protocol (SS7), the access point in the system is the trunk and switch at the end office. So for a given POTS telephone call, the calling party has point of origin that is a particular predetermined end office. Likewise, the called party's end office is the point of termination for the call. The end office for the calling party and the called party remain fixed and constant in POTS telephony, only the lines and networks between those end offices may vary.

Recently, technology has progressed to allow real-time voice communication over packet-switched networks such as the Internet. These voice-over-IP (VoIP) calls may occur between a calling party and called party that both have specialized VoIP telephones, or the calls may occur between a calling party and a called party wherein only one party has a specialized VoIP phone and the other party uses a POTS telephone. Even in this scenario, however, the access point into the VoIP network is unique. Instead of connecting to the network through an end office, a VoIP caller connects to the packet switched network via a network interface capable of sending data packets to and receiving data packets from the network. The network interface is typically connected to a router, TCP/IP (transmission control protocol/internet protocol) switch, or bridge. The purpose of this device is to read destination address information in each of the data packets and route them accordingly.

However, while telephone calls may be routed on any of a variety of lines or networks between originating and terminating end offices or routers, no consideration is given in the related art to determining the jurisdiction of the call prior to or during the process of determining how the call is routed (the set-up process). In other words, while different routes, involving different lines and networks, may have different costs to the carrier depending on their quality, capacity or bandwidth, or the contractual terms under which it may access those lines, these factors are not considered when the call is set-up. Only when the call is billed, long after it has ended, is this jurisdictional information taken into account.

What is needed is a way to route calls that makes it possible to determine the jurisdictional information about the calling party and the called party (or their respective end offices, router, or network access points in general) before or during the setting up of the call. Additionally, it would be of further use to be able to classify the jurisdiction of the call based on the relationship between the jurisdictional parameters of the called and calling parties, and then route the call based on this jurisdiction.

### SUMMARY OF THE INVENTION

Accordingly, the present invention is directed to a call routing system that substantially obviates one or more of the problems due to limitations and disadvantages of the related art.

An advantage of the present invention is to provide a call routing system capable of routing calls over a communications network more efficiently.

Another advantage of the present invention is to provide a call routing system capable of routing calls based on the jurisdiction of the call.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for routing a call between a point of origin and a point of termination comprises receiving a communications protocol message having a calling number and a called number; determining an A-index number relating to said point of origin; determining a B-index number relating to said point of termination; determining a route index based on a value of said B-index number; and determining a route for said call based on a value of said route index.

In another aspect of the present invention, a method for determining the jurisdiction of a call comprises identifying a first party's access point into a communications system; identifying a second party's access point into said communications system; obtaining a first party jurisdiction parameter for the first party's access point; obtaining a second party jurisdiction parameter for the second party's access point; and assigning a jurisdiction based on the relationship between the first party jurisdiction parameter and the second party jurisdiction parameter.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a call routing process according to an exemplary embodiment of the present invention.

FIGS. 2A and 2B illustrate a jurisdictional portion of a call routing process according to an exemplary embodiment of the present invention.

FIG. 3 illustrates sample data tables according to an exemplary embodiment of the present invention.

FIG. 4 illustrates sample tables according to an exemplary embodiment of the present invention.

FIG. 5 illustrates sample tables according to an exemplary embodiment of the present invention.

FIG. 6 illustrates sample tables according to an exemplary embodiment of the present invention.

FIG. 7 illustrates sample tables according to an exemplary embodiment of the present invention.

FIG. 8 illustrates sample tables according to an exemplary embodiment of the present invention.

### DETAILED DESCRIPTION OF THE ILLUSTRATED EMBODIMENTS

Reference will now be made in detail to an embodiment of the present invention, example of which is illustrated in the accompanying drawings.

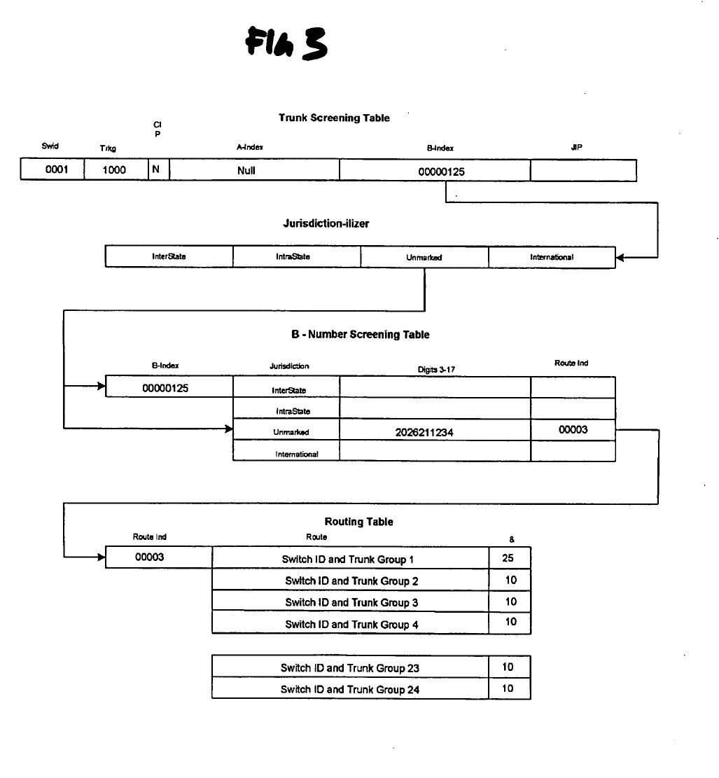

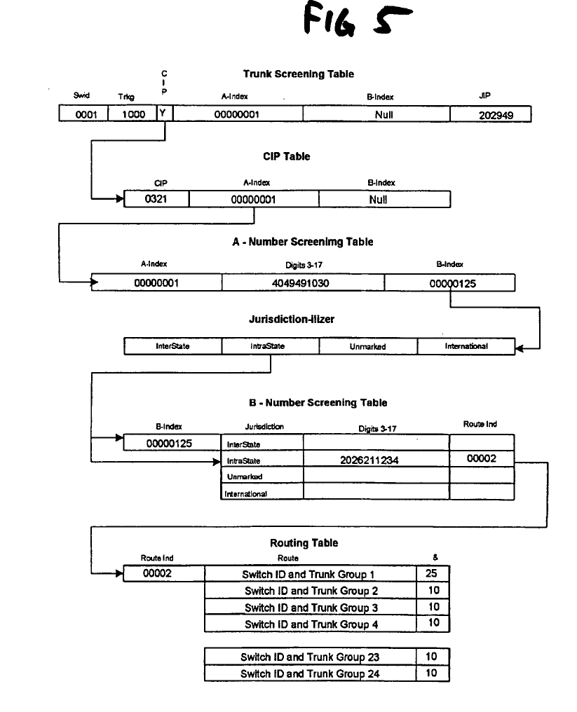

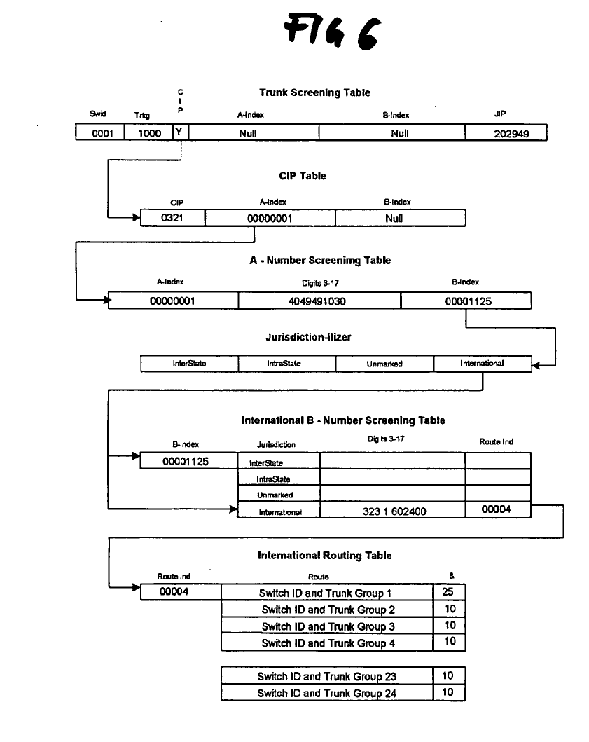

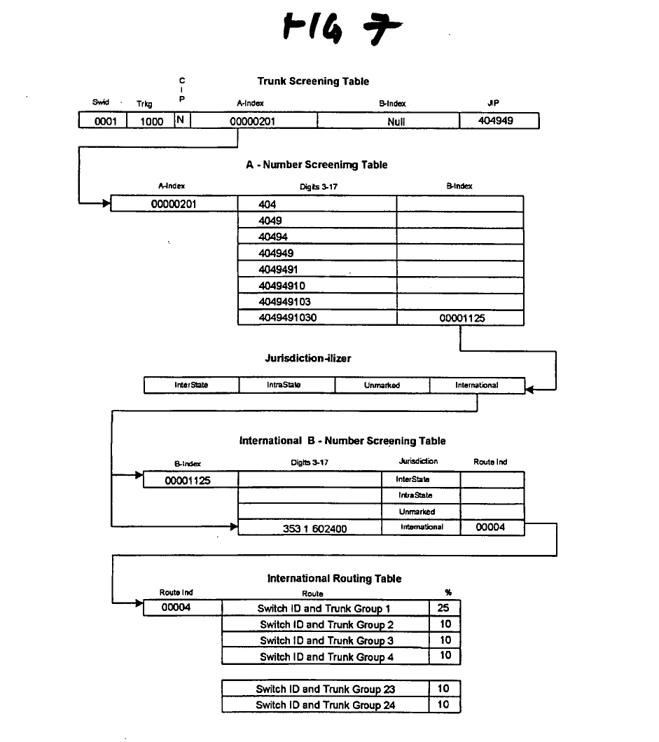

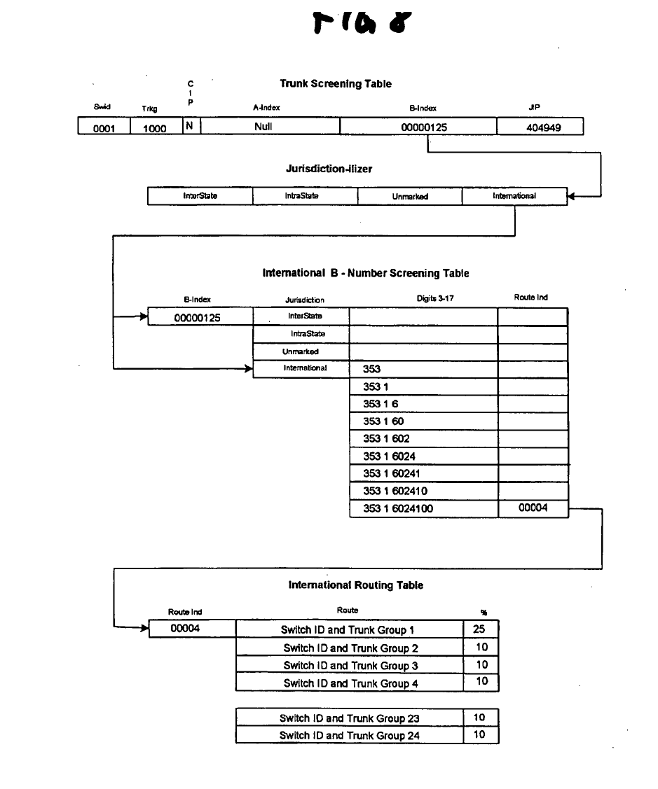

The jurisdictional processor of the present invention improves call routing efficiency and management by determining the jurisdiction of a call prior to the call is being and as the call is being set up. A first exemplary embodiment of the present invention uses six tables to route calls. The tables include a trunk screening table, an A-number screening table, a B-number screening table, and a routing table. In addition to these tables, the jurisdictional processor uses a jurisdiction table (state and local access transport area (LATA)) in conjunction with one or more of these tables to determine the call's jurisdiction and route the call accordingly. Examples of these tables are illustrated in FIGS. 3-8.

In a first exemplary embodiment, the trunk screening table has a predetermined number of records, each record of which has six fields. The fields include a switch ID number, a trunk group number, a carrier identification parameter (CIP), an A-index field, a B-index field and a jurisdiction parameter field. The A-index field and the B-index field are used as unique identifier of records in the A-number screening table and the B-number screening table, respectively. The A-number screening table includes fields A-index which is unique to each record in the A-number screening table, a field able to store, or screen against, telephone numbers having at least three digits and up to seventeen digits and finally a B-index field which serves as a look-up into the B-number screening table.

The B-number screening table includes a field for B-index, for jurisdiction, for digits three through seventeen of the called number, and for route index. The route index in the B-number screening table is used as a look-up into the routing table.

The routing table includes three fields. The first field in the route index which is unique to each record in the routing table. The second field is the route, which includes a combination of switch ID and trunk group number.

The jurisdictional processor of the present invention process, or routes, calls differently depending on the jurisdiction of the call. In a first aspect of the first exemplary embodiment of the present invention, the jurisdictional identification information is stored in a table. The jurisdiction table is a conceptual table in that it can either be implemented as an ordinary database table of the type similar to the trunk screening table, A-number or B-number screening table, or the routing table or the jurisdiction table may be implemented as a software program that processes input and provides a jurisdictional identification output.

In one aspect of the present invention, the jurisdiction table is used by a jurisdictional processor to identify one of four jurisdictions for the call. The four types of calls are interstate, intrastate, unmarked or international. Other aspects of this embodiment may provide for more types of jurisdiction, including combinations of the four listed above.

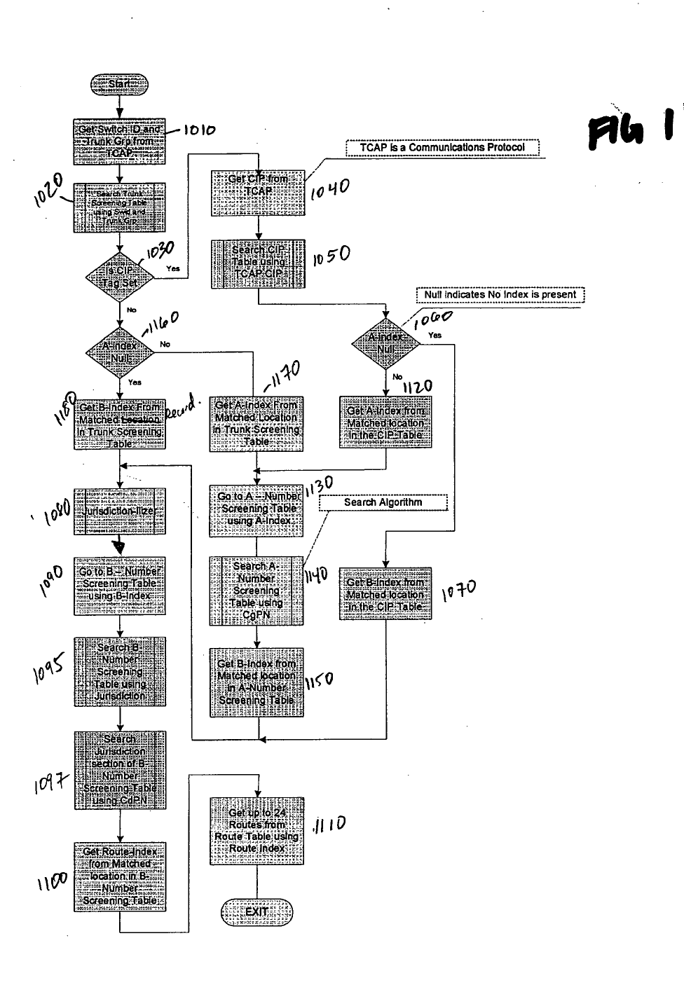

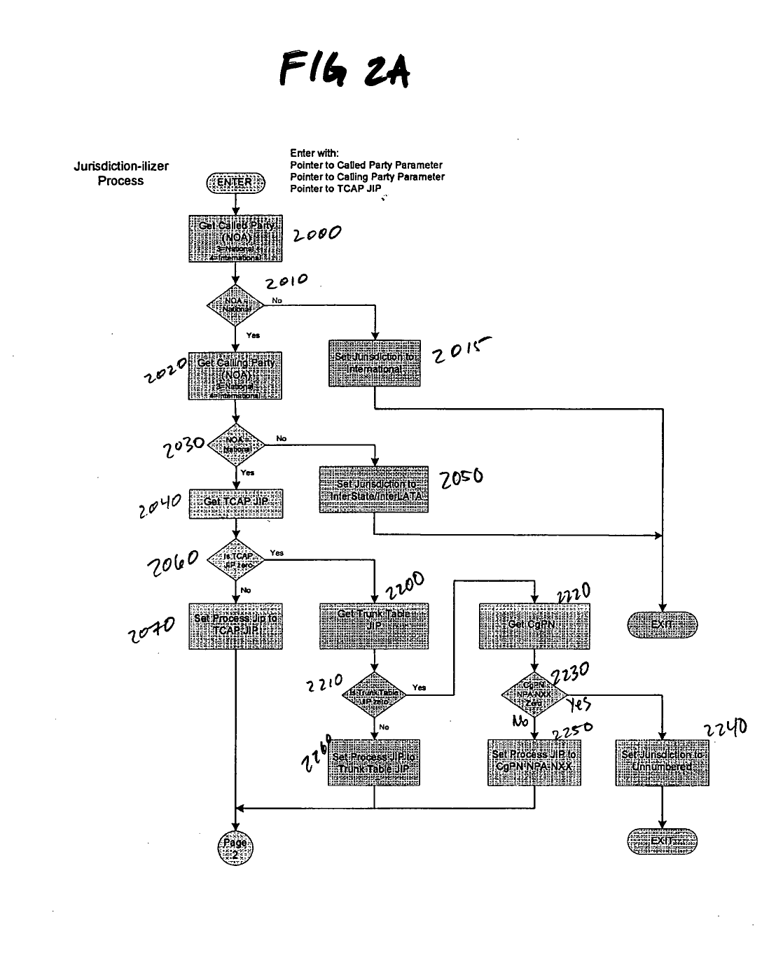

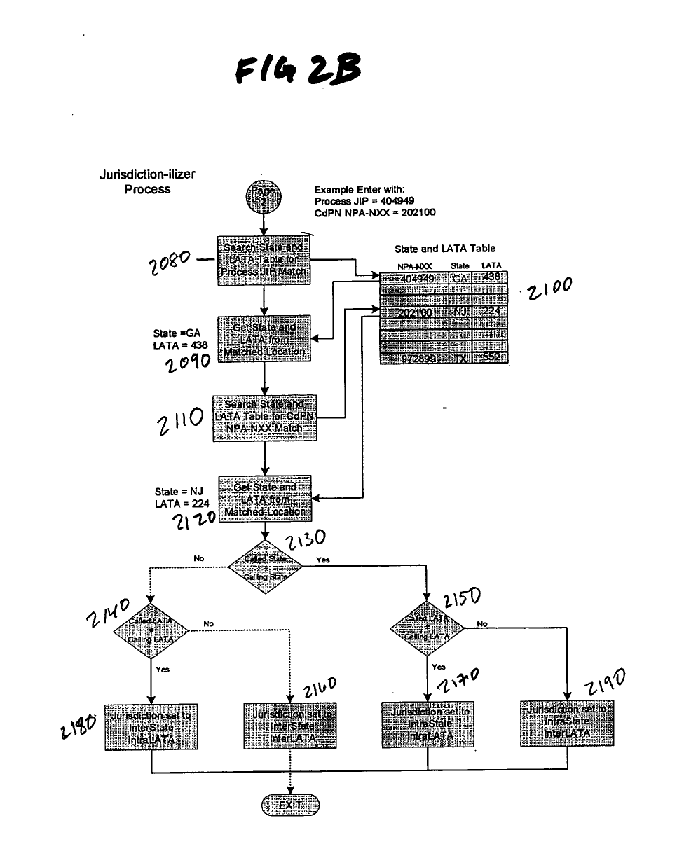

As illustrated in FIGS. 1, 2A, and 2B, the call routing process begins at step 1010 by obtaining the switch ID and the trunk group from the transaction capabilities application part (TCAP). In another embodiment, the switch ID is derived from information in the SCCP (signaling connection control part). The process then searches the trunk screening table using the switch ID and the trunk group at step 1020. At this point, the process determines in step 1030 whether the carrier identification parameter (CIP) in the trunk screening table is set. If the CIP is set to yes, then the value for CIP is taken from the TCAP at step 1040. In step 1050, the CIP table is searched for an A-index corresponding to this CIP value.

Once the CIP table is searched using the CIP obtained from the TCAP at step 1050, the process then determines whether the A-index value in the CIP table is null or not at step 1060. If the A-index in the CIP table is null (or zero), then the system obtains the B-index from that same record of the CIP table at step 1070. The system then proceeds to a jurisdictional processor at step 1080 which is discussed in greater detail below. Generally, in this embodiment the jurisdictional processor uses call information to determine which of a number of predetermined jurisdiction categories the call belongs.

In the aspect of the exemplary embodiment of the present invention discussed here, the jurisdiction may be set to any one of the following values: international, unnumbered, interstate/interLATA, interstate/intraLATA, intrastate/interLATA or intrastate/intraLATA.

The operation of the jurisdictional processor will be described with reference to FIGS. 2A and 2B in further detail below. Based the output from the jurisdictional processor, the process for routing the call then proceeds to step 1090 in FIG. 1, in which the B-number screening table is accessed using the same B-index value that was obtained in step 1070 from the CIP table. The process at step 1095 searches the B-number screening table based on a combination of the B-index and the jurisdiction value. In other words, in step 1090, once a record in the B-number screening table is identified based on the B-index value, then in this exemplary embodiment of the present invention there will be either a sub-table or additional records within that B-number screening table that share the same B-index value but have different values for the jurisdiction parameter.

In step 1095 the jurisdiction parameter from the jurisdictional processor in step 1080 is used to obtain the record with the combination of B-index from the CIP table in step 1070 and the jurisdiction parameter determined in step 1080. With these two pieces of information, a unique record in the B-number screening table is obtained. In addition, at step 1097, the jurisdiction section of the B-number screening table is searched for the called party number in the field capable of storing a minimum of three digits of telephone number information (such as an area code) to seventeen digits of the telephone number.

These pieces of information are combined in the B-number screening table to obtain the route index. This route index is used as a look-up into the routing table to obtain, in this particular exemplary embodiment, up to 24 routes from the route table using this route index. The route determines how the call is physically routed from the calling party to the called party. In other aspects of this invention, a more or fewer routes may be obtained from the route table, or only a single route may be obtained.

In this way, routes are obtained for the case in which the CIP tag is set but the A-index value is null. If the A-index value in step 1060 is not null, then in step 1120 the A-index is simply obtained from that record of the CIP table. In step 1130, that A-index value is used a look-up into the A-number screening table. In step 1140, once that record in the A-number screening table having that A-index is obtained, the calling party number is used to determine calling party number is used in step 1140 to determine the B-index value. At step 1150 the B-index value from that record of the A-number screening table is obtained by the process which passes that information along with all of the other information to the jurisdictional processor in 1080. The call routing process then proceeds as discussed above with respect to steps 1080 through 1140. However, returning to step 1030 if the CIP tag is set to null in the trunk screening table, then at step 1160 the process must determine if the A-index value in the trunk screening table is null or not. If the A-index value in the trunk screening table is not null, then at step 1170 that A-index value from the trunk screening table is obtained by the process and passed as the A-index value to step 1130. Then the call routing process proceeds as discussed above with respect to steps 1130 through 1150 and then on through the jurisdictional processor at step 1080 through step 1110. Finally, if the A-index value in the trunk screening table is null, then the B-index value from that record of the trunk screening table is obtained and passed to the jurisdictional processor is obtained at step 1180. In this manner, the call routing process is able to determine the jurisdiction and then properly route the call regardless of the information present or not present in the TCAP or trunk in the carrier identification parameter tables.

FIGS. 2A and 2B illustrate the jurisdictional processor according to a first exemplary embodiment of the present invention in great detail. As noted from the call routing process illustrated in FIG. 1, the jurisdictional processor at step 1080 is called with at least the following information: a pointer to the called party parameter, a pointer to the call in party parameter and a pointer to the value of the TCAP jurisdictional information parameter (JIP). The jurisdictional processor begins at step 2000 by obtaining the called party nature of address (NOA). In one aspect of this exemplary embodiment of the present invention, the NOA may have the value of three for national or four corresponding to international. At step 2010 the jurisdictional processor determines if the NOA is national. If the NOA is national, then at step 2020 the jurisdictional processor obtains the calling party NOA. Similarly, in one aspect of this exemplary embodiment of the present invention the calling party NOA may have a value of three corresponding to a national or four corresponding to international. The jurisdictional processor determines whether the calling party NOA is national or not at step 2030. If the calling party NOA is national, then the JIP or jurisdiction parameter from the TCAP is obtained at step 2040. If the calling party NOA is not national, then the jurisdictional processor sets the value of jurisdiction to interstate/interLATA in this exemplary embodiment of the present invention at step 2050. Once the jurisdiction is set to interstate/interLATA at step 2050, the jurisdictional processor exits and returns to the call routing process at step 1090 with that jurisdiction value set. Returning to the case where the calling party NOA is national, JIP is obtained from the TCAP and the process determines at step 2060 whether the value of the JIP jurisdiction parameter from the TCAP is zero or not. If the TCAP JIP is zero, then the process JIP of the jurisdictional processor is set to the non-zero value of the TCAP JIP at step 2070. Then the jurisdictional processor at step 2080 in FIG. 2B takes the value of the process JIP and searches the state and LATA table for a match. In other words, the state and LATA table illustrated in FIG. 2B includes fields for state, LATA, and a field commonly referred to as NPA-NXX.

At step 2090, the jurisdictional processor matches the process JIP against the value in the NPA-NXX field and obtains the state and LATA for the matching record. For example, if the jurisdictional processor enters step 2080 with a process JIP of 404949 and a called party number NPA-NXX of 202,100, then, at step 2080, the jurisdictional processor will use search the NPA-NXX field for a value corresponding to process JIP 404949. In this example, the NPA-NXX field with a value of 404949 has a state of “GA” and a LATA of 438, which is passed to step 2090 thereby obtaining the state and LATA information corresponding to process JIP.

At step 2110, that same table 2100 is used again, except at this step the called party number is used as a match against the NPA-NXX field. So, to continue the example, if the called party number NPA-NXX is 202100, the state and LATA table would be searched for a record in which the field NPA-NXX matches 202100. In this example, the record with an NPA-NXX of 202100 has a state of New Jersey and a LATA of 224. That state and LATA information is passed to step 2120 which passes it on to step 2130. At step 2130, a determination is made whether the called state and the calling state are equal. Recall that the called state is determined based on the look-up of the state and LATA table using the called party number as a match against the NPA-NXX and the calling state is determined based on using the process JIP as a look-up into the state and LATA table of NPA-NXX field. If the called state and the calling state are not the same, then a further determination is made at step 2140 of whether the called LATA and the calling LATA are the same. Recall again that the called LATA is obtained in steps 2110 and 2120 and the calling LATA is obtained in steps 2080 and 2090. If the called LATA and the calling LATA are the same, then the jurisdictional processor sets the jurisdiction to be “interstate/intraLATA” at step 2180. Then the jurisdictional processor exits with that jurisdiction value and resume the call routing process at step 1090.

If the called LATA and the calling LATA are not the same, then at step 2160 the jurisdictional processor sets the jurisdiction to be “interstate/interLATA”. Returning to step 2130, if the called state and the calling state are the same, then at step 2150 the determination is again made of whether of the called LATA and the calling LATA are the same. However, the outcome of this determination at step 2150 is different. If the called state and the calling state are the same and the called LATA and the calling LATA are the same, the jurisdictional processor at step 2170 will set the jurisdiction to “intrastate/intraLATA”. If the called state and the calling state are the same in 2130 but the called LATA and the calling LATA are not the same in step 2150, then the jurisdictional processor at step 2190 will set the jurisdiction to “intrastate/interLATA”. After the jurisdiction is set by any one of steps 2160 through 2190, the jurisdictional processor ends and resumes the call routing process at step 1090.

At steps 2010, in FIG. 2A, if the NOA of the called party is not national, then the jurisdictional processor at step 2015 sets the jurisdiction to “international” and exits returning to the call routing process at step 1090.

At step 2060, if the TCAP JIP is zero or null, then the jurisdictional processor takes the value of the JIP from the trunk table at step 2200. However, it is also possible that the trunk table JIP may be zero. Therefore, if the trunk table JIP is zero, then the calling party number is used in step 2220. If the calling party NPA-NXX is zero, a determination is made at step 2230 of whether the calling party NPA-NXX is zero. If the calling party NPA-NXX is zero, then the jurisdictional processor sets the jurisdiction to “unnumbered” (or “unmarked”) and exits at step 2240.

If the calling party NPA-NXX is not zero, then the process JIP is set to the calling party NPA-NXX and the system proceeds to step 2080. In this way the number of circumstances in which the jurisdiction must be set to unnumbered is minimized. This is of particular importance because it allows more efficient routing of a greater bonding of the call provided through a process in which any embodiment of the jurisdictional processor is used. Returning to step 2210, if the trunk table JIP is zero, then the process JIP is set in step 2260 to the value of the trunk table JIP. Once a process JIP is set to this value, the jurisdictional processor proceeds to step 2080 and begins a look-up into the state and LATA tables.

In other aspects of this exemplary embodiment the process JIP may be set according to different rules in cases in which the JIP fields within various tables or at various stages of the process are null or not.

FIG. 3 illustrates one aspect of an embodiment of the present invention. FIG. 3 illustrates the call routing process from the perspective of the data tables containing the information are used to route the calls. Therefore, for example, if at step 1030 illustrated in Figure the determination of whether the CIP tag is set in the trunk screening table is illustrated in FIG. 3 with a trunk screening table having records switch ID, trunk group, CIP, A-index, B-index and JIP. In FIG. 3, the CIP value is shown as null, therefore, at step 1030 of the call routing process the CIP tag is detected to be null and then the A-index value is identified as null or not in FIG. 3 of the A-index value is illustrated to be null which means that the call routing process proceeds to step 1180 in which the B-index value is obtained from the trunk screening table. If, for example, the result of the after the B-index value is obtained, the call routing process as discussed above proceeds to step 1080 and the jurisdictional processor operates to determine the jurisdiction of the call as any one of unnumbered, international, interstate/intraLATA, interstate/interLATA, intrastate/intraLATA or intrastate/interLATA.

For example, in FIG. 3 if the jurisdictional processor identifies the jurisdiction of a call as being unmarked, then the call routing process uses the B-index number from the trunk screening table as well as the value of unmarked for the jurisdiction set by the jurisdictional processor as look-ups into the B-number screening table. In the exemplary embodiment illustrated in FIG. 3 the B-number screening table contains records that are unique for a combination of B-index value and jurisdiction value. In other words, the B-index value may be the same for any one of four jurisdiction parameter values of interstate, intrastate, unmarked or international. In another exemplary embodiment the B-number screening table is unique for only the B-index value meaning that there is only a single B-index there is a unique B-index for every record of the B-number screening table. However, in that exemplary embodiment the call routing process is required an additional table that matches B-index values with jurisdiction values to determine the route index. However, returning to the example in which the B-number screened table contains both B-index and jurisdiction values that in combination are unique for each record of the B-number screening table. The called party number is used as a look-up in addition to the B-index value and the jurisdiction value to obtain the route index.

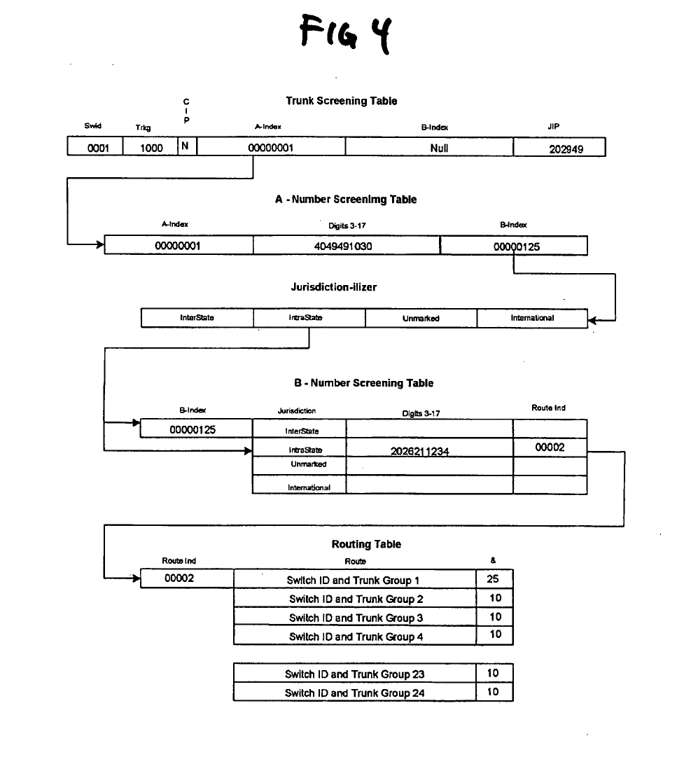

For example, in FIG. 3 the B-number screening table is matched with a value of 125 for the B-index which was obtained from the trunk screening table as well as the value of unmarked for jurisdiction from the jurisdictional processor and in this example a called party number of 2026211234 to obtain a route index of 3. The route index of 3 is used in the step 1100 of the call routing process illustrated in FIG. 1 as a look-up into the routing table. Thus, for route index 3 there are any number of different combinations of switch ID and trunk group having various costs or weighting factors associated with it. For example, in one aspect of this exemplary embodiment of the present invention the route is a combination of the switch ID and a trunk group that identifies and has a cost of routing the call through that switch ID and trunk group that may be different for each combination of switch ID and trunk group along that particular route. In a second aspect, rather than cost, the weighting factor of may be the load, or the number of calls being handled, on the route defined by that combination of switch ID and trunk group. In a further aspect, rather than the number of calls or the cost, the weighting factor may be the quality of the line through that switch ID and trunk group based on, for example, audio quality or electrical characteristics. Any one of a wide variety of characteristics are contemplated by the present invention as a way of determining which route may be more or less preferable depending on the jurisdiction of the call. Therefore, if the weighting factor of the switch ID and trunk group route is the cost of the line, then it may be desirable to route a less expensive call onto a less expensive line. However, the same system may be used to determine that a call that is deemed important, such as a 911 calls or an emergency calls should be routed onto the line with the most available bandwidth, the lines that have high quality, the lines that are more expensive and therefore likely to be less trafficked. FIGS. 4 through 8 illustrate additional examples of the call routing process of the first exemplary embodiment in which the CIP value may or may not be set and in which the A-index value may or may not be null within the trunk screening table as well as the operation of different values of jurisdiction coming from the jurisdictional processor.

However, all of FIGS. 3 through 8 use examples in which the trunk screening table, CIP table, A and B-number screening table, jurisdictional processor and routing tables, regardless of whether they are interstate or international routing tables, are conceptualized as tables in a database. It should be understood by one of ordinary skill in the art that the present invention contemplates using any variety of means of implementing the call routing process.

This could be tables within the trunks and switches that are commonly found in the telephone network but they may also be implemented in new pieces of hardware in the form of software programs for databases running on general purpose computers or general purpose computers acting as servers that are running a industry-standard database management program. However, it is expected that to implement the jurisdictional processor of the present invention in the current telephone call management system using the trunk screening table, a CIP table, A or B-index, A and B-number screening tables and routing tables that the jurisdictional processor be inserted as a means in providing an additional level of look-up into the B-number screening table. This could be accomplished in a variety of different aspects of the invention by either altering the B-number screening table itself or running an additional table that requires a call routing process to proceed first in the B-number screening table or as a look-up and then to a jurisdiction/B-number screening table which provides look-ups for combinations of B-index and jurisdictional processor as well as the telephone number.

The call routing process illustrated in FIG. 1 may be implemented without the jurisdictional processor illustrated in FIG. 3 and still provide significant advantages over the related art call routing system. Likewise, the jurisdictional processor of FIG. 3 may be implemented in call routing processes other than what is illustrated in FIG. 1 and still provide the benefit of the jurisdictional function.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for routing a call between a point of origin and a point of termination, comprising:
receiving a communications protocol message having a calling number and a called number;
determining an A-index number relating to said point of origin;
determining a B-index number relating to said point of termination;
determining a route index based on a value of said B-index number; and
determining a route for said call based on a value of said route index.

2. The method of claim 1, wherein said determining said A-index number comprises:
obtaining a trunk group and switch ID from the communications protocol message
searching a trunk screening table for the value of an A-index field corresponding to said trunk group and switch ID; and
determining the value of the A-index number to be the value of the A-index field in the trunk screening table when the value of the A-index field is not zero or null;

3. The method of claim 1, wherein said determining said A-index number comprises:
obtaining a CIP from the communications protocol message;
searching a CIP table for the value of an A-index field corresponding to said CIP; and
determining the value of the A-index number to be the value of the A-index field in the CIP table when the value of the A-index field is not zero or null.

4. The method of claim 2, comprising:
searching an A-number screening table on the A-index number and the calling party number; and
determining the value of the B-index number to be the value of a B-index field in the A-number screening table corresponding to the A-index number and the calling party number.

5. The method of claim 2, wherein determining a B-index number further comprises:
determining the value of the B-index number to be the value of a B-index field in the trunk screening table when the A-index number is null or zero.

6. The method of claim 3, wherein determining a B-index number further comprises:
determining the value of the B-index number to be the value of a B-index field in the CIP table when the A-index number is null or zero.

7. The method of claim 1, wherein determining a route-index number further comprises:
searching a B-number screening table on at least the B-index number and the called number; and
obtaining a route-index from the B-number screening table corresponding to at least the B-index number and the called number.

8. The method of claim 7, wherein determining a route further comprises:
searching a route table based on said route-index for at least one route between said point of origin and said point of termination.

9. The method of claim 1, wherein said point of origin is an originating end office and said point of termination is a terminating end office.

10. The method of claim 7, wherein said determining a route further comprises:
determining a jurisdiction of the call,
wherein said searching the B-number screening table comprises searching on said jurisdiction in addition to the B-index number and the called number.

11. The method of claim 10, wherein said step of determining the jurisdiction of the call occurs after the receiving a communications protocol message having a calling number and a called number but before the step of searching the B-number screening table.

12. A method for determining the jurisdiction of a telephone call, comprising:
obtaining a jurisdiction parameter;
obtaining a called number central office code;
obtaining a state value and local access transport area (LATA) value for jurisdiction of the calling number's end office by searching a state and LATA table for said jurisdiction parameter;
obtaining a state value and local access transport area (LATA) value for the terminating end office by searching a state and LATA table for said called number central office code;
determining the jurisdiction of the call based on the state and LATA values of the originating end office and the terminating end office.

13. The method of claim 12, further comprising:
determining that the jurisdiction of the call is “interstate/interLATA” if the called state and the calling state are unequal and if the called LATA and the calling LATA are unequal.

14. The method of claim 12, further comprising:
determining that the jurisdiction of the call is “intrastate/intraLATA” if the called state and the calling state are equal and if the called LATA and the calling LATA are equal.

15. The method of claim 12, further comprising:
determining that the jurisdiction of the call is “interstate/intraLATA” if the called state and the calling state are unequal and if the called LATA and the calling LATA are equal.

16. The method of claim 12, further comprising:
determining that the jurisdiction of the call is “intrastate/interLATA” if the called state and the calling state are equal and if the called LATA and the calling LATA are unequal.

17. A method for determining the jurisdiction of a call, comprising:
identifying a first party's access point into a communications system;
identifying a second party's access point into said communications system;
obtaining a first party jurisdiction parameter for the first party's access point;
obtaining a second party jurisdiction parameter for the second party's access point; and
assigning a jurisdiction based on the relationship between the first party jurisdiction parameter and the second party jurisdiction parameter.

18. The method of claim 17, wherein said jurisdiction parameter comprises a state and a local access transport area value.

19. The method of claim 18, further comprising:
determining that the jurisdiction of the call is “interstate/interLATA” if the state of the first party's access point and the state of the second party's access point are unequal and if the LATA of the first party's access point and the LATA of the second party's access point are unequal.

20. The method of claim 18, further comprising:
determining that the jurisdiction of the call is “intrastate/intraLATA” if the state of the first party's access point and the state of the second party's access point are equal and if the LATA of the first party's access point and the LATA of the second party's access point are equal.

21. The method of claim 18, further comprising:
determining that the jurisdiction of the call is “interstate/intraLATA” if the state of the first party's access point and the state of the second party's access point are unequal and if the LATA of the first party's access point and the LATA of the second party's access point are equal.

22. The method of claim 18, further comprising:
determining that the jurisdiction of the call is “intrastate/interLATA” if the state of the first party's access point and the state of the second party's access point are equal and if the LATA of the first party's access point and the LATA of the second party's access point are unequal.

23. The method of claim 17, wherein at least one of said first party's or said second party's access point into a communications system is an end office.

24. The method of claim 17, wherein at least one of said first party's or said second party's access point into a communications system is a router capable of routing data packets on a packet-switched network.

25. The method of claim 17, wherein said communications system is a wireless communications system.

26. The method of claim 17, wherein at least one of said first party's or said second party's access point into a communications system is a network interface device interfacing to a packet-switched network.
